(19) United States
(12) Patent Application Publication
(10) Pub. No.: US 2026/0341931 A1
(43) Pub. Date: Oct. 29, 2026

(54) ELECTRODE ASSEMBLY AND SECONDARY BATTERY HAVING THE SAME

(71) Applicant: Samsung SDI Co., Ltd., Yongin-si (KR)

(72) Inventors: Yong Chan Kim, Yongin-si (KR); Jae Yound Lee, Yongin-si (KR); Jun Seo Yun, Yongin-si (KR); Jeong Won Oh, Yongin-si (KR)

(73) Assignee: Samsung SDI Co., Ltd., Yongin-si (KR)

(21) Appl. No.: 19/657,784

(22) Filed: Apr. 24, 2026

(30) Foreign Application Priority Data
Apr. 25, 2025 (KR) 10-2025-0054675

(51) Int. Cl. H01M 50/595; B60L 50/64; H01M 10/0587; H01M 50/103; H01M 50/107; H01M 50/119; H01M 50/586

(52) U.S. Cl. CPC H01M 50/595; H01M 10/0587; H01M 50/103; H01M 50/107; H01M 50/119; H01M 50/586; B60L 50/64; H01M 2220/20

(57) ABSTRACT

An electrode assembly is provided including: a first electrode plate including a first substrate and a first active material layer disposed on the first substrate, wherein the first substrate includes a substrate horizontal edge corresponding to a winding start end of the first electrode plate and parallel to a winding axis, a substrate vertical edge perpendicular to the substrate horizontal edge, and a substrate corner between the substrate horizontal edge and the substrate vertical edge; a second electrode plate including a second substrate and a second active material layer disposed on the second substrate; a separator disposed between the first and second electrode plates; and a protection tape attached to the substrate corner, wherein at least a portion of the substrate horizontal edge other than the substrate corner remains exposed from the protection tape. A secondary battery including the electrode assembly is further provided.

### CROSS-REFERENCE TO RELATED APPLICATION

This present application claims priority to and the benefit under 35 U.S.C. § 119(a)-(d) of Korean Patent Application No 10-2025-0054675, filed on Apr. 25, 2025, in the Korean Intellectual Property Office, the entire disclosure of which is incorporated herein by reference.

### BACKGROUND

### Field

Embodiments of the present disclosure relate to an electrode assembly and a secondary battery having the same.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments of the present disclosure provide an electrode assembly capable of preventing an internal short circuit that may occur due to substrate folding of an electrode plate, and a secondary battery including the same. For example, embodiments of the present disclosure provide an electrode assembly and a secondary battery including the same that prevent the occurrence of metal foreign substances or folding in a battery cell, thereby ensuring safe battery operation.

Embodiments of the present disclosure also provide an electrode assembly in which a protection tape is attached to a region where folding may occur in a lithium-ion battery, thereby improving the stability of the electrode assembly and the separator of the battery, and a secondary battery including the same.

Embodiments of the present disclosure also provide an electrode assembly configured such that the protection tape may be applied to prismatic, cylindrical, or pouch-type lithium-ion battery cells, thereby enabling operation in various types of battery cells, and a secondary battery including the same.

According to some embodiments, an electrode assembly may include: a first electrode plate including a first substrate and a first active material layer disposed on the first substrate, the first substrate including a substrate horizontal edge corresponding to a winding start end of the first electrode plate and extending parallel to a winding axis, a substrate vertical edge perpendicular to the substrate horizontal edge, and a substrate corner between the substrate horizontal edge and the substrate vertical edge; a second electrode plate including a second substrate and a second active material layer disposed on the second substrate; a separator between the first electrode plate and the second electrode plate; and a protection tape attached to the substrate corner, wherein at least a portion of the substrate horizontal edge, excluding the substrate corner, is exposed from the protection tape.

In one or more embodiments, an area of the protection tape may be 100% to 110% of an area of a maximum substrate folding region generated at the substrate corner of the first substrate.

In one or more embodiments, the protection tape may cover, on the first substrate, a minimum square region including a diagonal length Z=√(X²+Y²), wherein X may be a maximum horizontal substrate folding distance formed on the substrate horizontal edge, Y may be a maximum vertical substrate folding distance formed on the substrate vertical edge, and Z may be a maximum diagonal substrate folding distance connecting one end of the maximum horizontal substrate folding distance and one end of the maximum vertical substrate folding distance in a diagonal direction.

In one or more embodiments, the protection tape may be attached from one side of the substrate corner to the first active material layer that extends parallel to the substrate horizontal edge.

In one or more embodiments, the substrate corner may be provided at both sides of the substrate horizontal edge, and the protection tape may be attached to each of the substrate corners provided at the both sides of the substrate horizontal edge.

In one or more embodiments, the first substrate may include a first surface facing the second active material layer of the second electrode plate on an outer side of the first substrate, and a second surface opposite to the first surface and facing the separator on an inner side of the first substrate, and wherein the protection tape is attached to the first surface.

In one or more embodiments, the protection tape may include PET (polyethylene terephthalate) or PPS (polyphenylene sulfide).

In one or more embodiments, the first electrode plate, the second electrode plate, and the separator between the first electrode plate and the second electrode plate may be stacked together and wound in a jelly-roll form.

In one or more embodiments, the first electrode plate, the second electrode plate, and the separator between the first electrode plate and the second electrode plate may be stacked together and wound in a cylindrical form.

In one or more embodiments, the first electrode plate may be a positive electrode plate, and the second electrode plate may be a negative electrode plate.

In one or more embodiments, the second substrate may include a terminal substrate horizontal edge corresponding to a winding terminal end of the second electrode plate and extending parallel to the winding axis, a terminal substrate vertical edge perpendicular to the terminal substrate horizontal edge, and a terminal substrate corner between the terminal substrate horizontal edge and the terminal substrate vertical edge, wherein the electrode assembly may further include a terminal protection tape attached to the terminal substrate corner, and wherein at least a portion of the terminal substrate horizontal edge, excluding the terminal substrate corner, may be exposed from the terminal protection tape.

In one or more embodiments, an area of the terminal protection tape may be 100% to 110% of an area of a maximum substrate folding region generated at the terminal substrate corner of the second substrate.

In one or more embodiments, the terminal protection tape may cover, on the second substrate, a minimum square region including a diagonal length Z=√(X²+Y²), wherein X may be a maximum horizontal substrate folding distance formed on the terminal substrate horizontal edge, Y may be a maximum vertical substrate folding distance formed on the terminal substrate vertical edge, and Z may be a maximum diagonal substrate folding distance connecting one end of the maximum horizontal substrate folding distance and one end of the maximum vertical substrate folding distance in a diagonal direction.

In one or more embodiments, the terminal substrate corner may be provided at both sides of the terminal substrate horizontal edge, and the terminal protection tape may be attached to each of the terminal substrate corners provided at the both sides.

In one or more embodiments, the second substrate may include a first surface facing the first electrode plate on an inner side of the second substrate and a second surface opposite to the first surface and facing the first electrode plate on an outer side of the second substrate, and wherein the terminal protection tape maybe attached to the first surface or the second surface.

In one or more embodiments, the terminal protection tape may include an insulating tape.

According to some embodiments, a secondary battery may include the electrode assembly.

In one or more embodiments, the electrode assembly may be accommodated in a prismatic metal case.

In one or more embodiments, the electrode assembly may be accommodated in a cylindrical metal case.

In one or more embodiments, the electrode assembly may be accommodated in a pouch-type exterior material.

These and other aspects and features of the present disclosure will be described in or will be apparent from the following description of embodiments of the present disclosure.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view illustrating a secondary battery according to embodiments of the present disclosure.

FIG. 2 is a cross-sectional view taken along line 2-2 of FIG. 1.

FIG. 3 is a cross-sectional view of an electrode assembly taken along line 3-3 of FIG. 1.

FIG. 4 is an enlarged view of region 4 of FIG. 3.

FIG. 5 is a view illustrating separator damage and a short-circuit phenomenon in an electrode assembly when a protection tape is not provided.

FIG. 6 is a view illustrating a state in which a protection tape is attached to an electrode plate according to embodiments of the present disclosure.

FIG. 7 is a plan view illustrating an electrode plate to which a protection tape is attached according to embodiments of the present disclosure.

FIG. 8 is a plan view illustrating an electrode plate to which a protection tape is attached according to another embodiment of the present disclosure.

FIG. 9 is a cross-sectional view illustrating an electrode assembly according to another embodiment of the present disclosure.

FIG. 10 is a plan view illustrating an electrode plate to which a protection tape is attached according to another embodiment of the present disclosure.

FIG. 11 is a plan view illustrating an electrode plate to which a protection tape is attached according to another embodiment of the present disclosure.

FIG. 12 is a perspective view illustrating a secondary battery according to another embodiment of the present disclosure.

FIG. 13 is a cross-sectional view taken along line 13-13 of FIG. 12.

FIG. 14 is a cross-sectional view taken along line 14-14 of FIG. 12.

FIG. 15 is an enlarged view of region 15 of FIG. 14.

FIG. 16 is a view illustrating separator damage and a short-circuit phenomenon in an electrode assembly when a protection tape is not provided.

FIG. 17 is a plan view illustrating a secondary battery according to another embodiment of the present disclosure.

FIG. 18 is an exploded perspective view illustrating a secondary battery according to another embodiment of the present disclosure.

FIG. 19 is a perspective view illustrating a battery module according to one or more embodiments of the present disclosure.

FIGS. 20 and 21 are perspective views showing a battery pack including an exemplary cylindrical secondary battery according to the present disclosure.

FIGS. 22 and 23 are perspective and side views showing a vehicle including an exemplary battery pack according to the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

Lithium-ion secondary batteries were initially developed mainly for use in batteries employed in small electronic devices such as mobile phones and laptop computers. However, in recent years, their applications have expanded to large-scale power storage systems such as electric vehicles and energy storage systems (ESS), and the demand for high-capacity secondary batteries has rapidly increased. In such high-capacity secondary batteries, not only high power performance and long service life but also safety has emerged as a very important requirement.

In particular, when abnormal phenomena such as metallic foreign substances, substrate folding, or burrs occur inside a battery, such phenomena may damage a separator within the battery. Since the separator plays an important role in preventing a short circuit by separating the positive electrode and the negative electrode, damage to the separator increases the risk that the positive electrode and the negative electrode may come into contact with each other, thereby causing a short circuit. As a result, an internal short-circuit failure mode may occur within the battery, which may seriously affect the safety of the battery.

Hereinafter, an electrode assembly according to embodiments of the present disclosure and a secondary battery including the same, which address the herein-described problems, is further described.

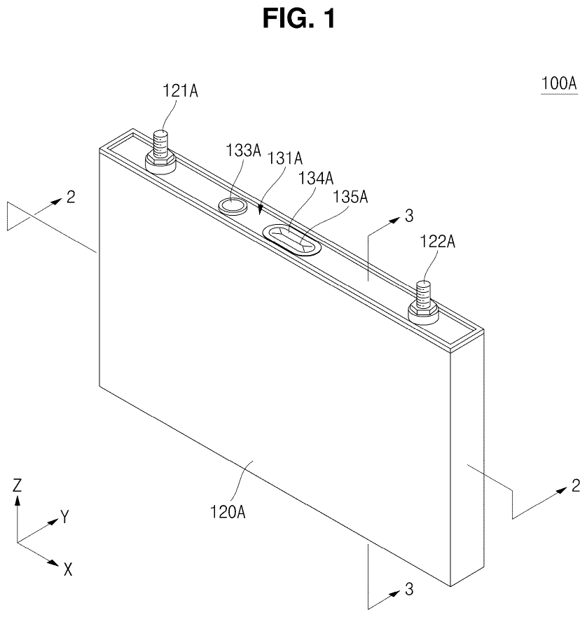

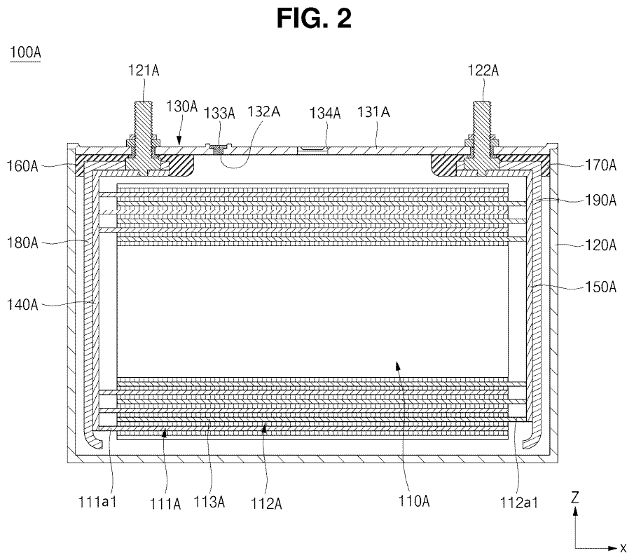

FIG. 1 is a perspective view illustrating a secondary battery 100A according to embodiments of the present disclosure, and FIG. 2 is a cross-sectional view taken along line 2-2 of FIG. 1. In the example shown in FIGS. 1 and 2, the secondary battery 100A according to embodiments of the present disclosure may include an electrode assembly 110A, a case 120A in which the electrode assembly 110A is accommodated, and a cap assembly 130A coupled to the case 120A.

The electrode assembly 110A may include a first electrode plate 111A, a second electrode plate 112A, and a separator 113A interposed between the first electrode plate 111A and the second electrode plate 112A, and these components may be wound in a jelly-roll form or a prismatic form. In addition, the electrode assembly 110A may include a first substrate tab 111a1 extending through one side (for example, a left side) and a second substrate tab 112a1 extending through the other side (for example, a right side) of the electrode assembly 110A. When the first electrode plate 111A operates as a positive electrode, the second electrode plate 112A may operate as a negative electrode. Conversely, when the first electrode plate 111A operates as a negative electrode, the second electrode plate 112A may operate as a positive electrode. The electrode assembly 110A may include or may be referred to as an electrode stack, an electrode body, or a jelly-roll. The electrode assembly 110A will be described in further detail herein.

The case 120A forms the overall exterior of the secondary battery 100A and may be formed of a conductive metal such as aluminum, an aluminum alloy, or nickel-plated steel. The case 120A may also provide a space in which the electrode assembly 110A is accommodated. In one or more embodiments, the case 120A may have a prismatic shape in which an upper portion is open while the remaining portion is closed. The case 120A may include or may be referred to as a can, a housing, or an exterior material.

The cap assembly 130A may include a cap plate 131A covering an opening of the case 120A, and the case 120A and the cap plate 131A may be formed of a conductive material. In one or more embodiments, a first electrode terminal 121A and a second electrode terminal 122A, which are electrically connected to the first electrode plate 111A and the second electrode plate 112A, respectively, may be installed to pass through the cap plate 131A and protrude outward from the cap plate 131A. An outer circumferential surface of upper pillar portions of the first electrode terminal 121A and the second electrode terminal 122A protruding outward from the cap plate 131A may be threaded and may be fixed to the cap plate 131A by a nut. However, the present disclosure is not limited thereto, and the first electrode terminal 121A and the second electrode terminal 122A may have a rivet structure and may be riveted, or may be welded and coupled to the cap plate 131A. The cap assembly 130A may include or may be referred to as a lid, a cover, or a case cover.

The cap plate 131A may be formed as a thin plate and may be coupled to the opening of the case 120A. An electrolyte injection port 132A into which a sealing plug 133A may be installed may be formed in the cap plate 131A, and a safety vent 134A having a notch may be provided in the cap plate 131A. In some examples, the safety vent 134A may close a vent hole provided in the cap plate 131A. In some examples, the safety vent 134A may be coupled or welded to a region surrounding the vent hole (i.e., a region of the cap plate).

The first electrode terminal 121A and the second electrode terminal 122A may be electrically connected to a first current collector 140A and a second current collector 150A, respectively, which are joined to the first substrate tab 111a1 and the second substrate tab 112a1 by welding. In one or more embodiments, the first electrode terminal 121A and the second electrode terminal 122A may be welded to the first current collector 140A and the second current collector 150A, respectively. However, the present disclosure is not limited thereto, and the first electrode terminal 121A and the second electrode terminal 122A and the first current collector 140A and the second current collector 150A may be provided as integrally combined structures.

An insulating member may be disposed between the electrode assembly 110A and the cap plate 131A. The insulating member may include a first lower insulating member 160A and a second lower insulating member 170A, and each of the first lower insulating member 160A and the second lower insulating member 170A may be disposed between the electrode assembly 110A and the cap plate 131A.

In one or more embodiments, a separating member that may be disposed to face one side surface of the electrode assembly 110A may be provided between the first and second insulating members 160A and 170A and the first and second terminals 121A and 122A. The separating member may include a first separating member 180A and a second separating member 190A. Accordingly, the first separating member 180A and the second separating member 190A may be respectively disposed between the first and second lower insulating members 160A and 170A and the first and second electrode terminals 121A and 122A, and may be arranged to face a side surface of the electrode assembly 110A.

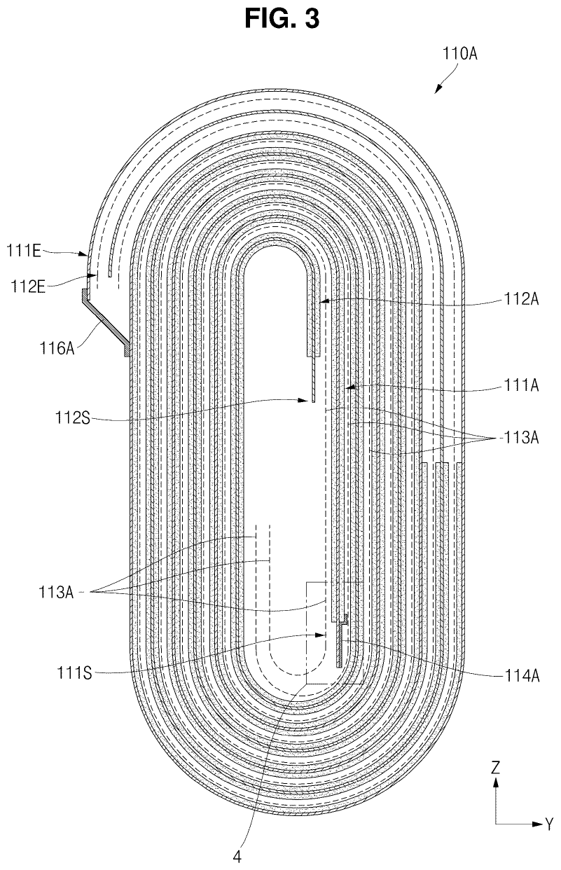

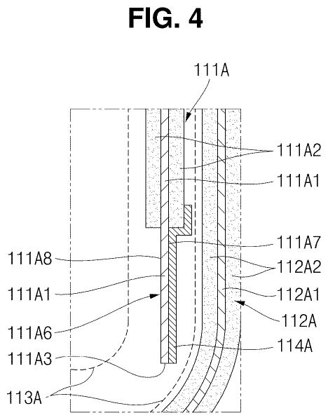

FIG. 3 is a cross-sectional view of the electrode assembly 110A taken along line 3-3 of FIG. 1, and FIG. 4 is an enlarged view of region 4 of FIG. 3.

As illustrated in FIGS. 3 and 4, the electrode assembly 110A may include a first electrode plate 111A, a second electrode plate 112A, and a separator 113A disposed between the first electrode plate 111A and the second electrode plate 112A. The electrode assembly 110A may be provided such that the first electrode plate 111A, the second electrode plate 112A, and the separator 113A between the first electrode plate 111A and the second electrode plate 112A are stacked and wound in a jelly-roll form.

The first electrode plate 111A may include a first substrate 111A1 (e.g., a positive electrode current collector or a positive electrode conductor) and a first active material layer 111A2 (e.g., a positive electrode active material) disposed on the first substrate 111A1. The first electrode plate 111A may include a winding start end 111S at which winding begins and a winding terminal end 111E at which the winding terminates.

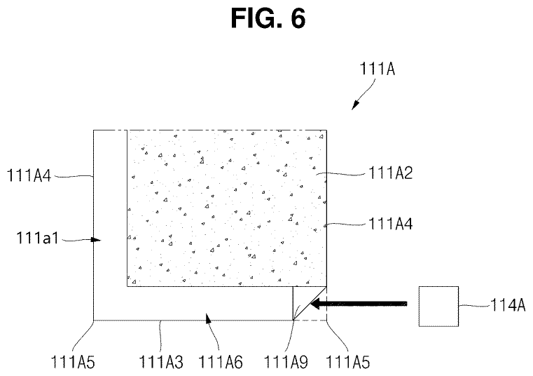

In one or more embodiments, the first substrate 111A1 may include a substrate horizontal edge 111A3 corresponding to the winding start end 111S of the first electrode plate 111A and extending parallel to a winding axis, a substrate vertical edge 111A4 perpendicular to the substrate horizontal edge 111A3, and a substrate corner 111A5 between the substrate horizontal edge 111A3 and the substrate vertical edge 111A4 (see FIGS. 6, 7, and 8). In one or more embodiments, a portion of the first substrate 111A1 defined by the substrate horizontal edge 111A3, the substrate vertical edge 111A4, and the substrate corner 111A5 may be referred to as a first uncoated substrate region 111A6. The first uncoated substrate region 111A6 may be exposed from the first active material layer 111A2. In other words, the first uncoated substrate region 111A6 may be exposed without being covered by the first active material layer 111A2.

The second electrode plate 112A may include a second substrate 112A1 (e.g., a negative electrode current collector or a negative electrode conductor) and a second active material layer 112A2 (e.g., a negative electrode active material) disposed on the second substrate 112A1. The second electrode plate 112A may include a winding start end 112S at which winding begins and a winding terminal end 112E at which the winding terminates. In one or more embodiments, the second substrate 112A1 may include a substrate horizontal edge corresponding to the winding start end 112S of the second electrode plate 112A and extending parallel to a winding axis, a substrate vertical edge perpendicular to the substrate horizontal edge, and a substrate corner between the substrate horizontal edge and the substrate vertical edge. In one or more embodiments, a portion of the second substrate 112A1 defined by the substrate horizontal edge, the substrate vertical edge, and the substrate corner may be referred to as a second uncoated substrate region, which may be exposed from the second active material layer 112A2. The winding start end 111S of the first electrode plate 111A may be spaced apart from the winding start end 112S of the second electrode plate 112A in a vertical direction (e.g., a Z-axis direction).

Herein, the winding axis may refer to a central line about which an electrode plate or an electrode assembly rotates or is wound when the electrode plate or the electrode assembly is wound (e.g., the X-axis in FIG. 2). The electrode plate or the electrode assembly may be wound about the winding axis in a jelly-roll type, a prismatic type, or a cylindrical type, thereby forming a structure of a battery cell.

In one or more embodiments, a protection tape 114A may be attached to the first electrode plate 111A. In one or more embodiments, the protection tape 114A may be attached to the substrate corner 111A5 of the first electrode plate 111A, thereby preventing folding at that portion and improving the safety of the battery. In other words, the protection tape 114A may reinforce the rigidity of the substrate corner 111A5 so that the substrate corner 111A5 does not easily fold during a manufacturing process. In addition, when a burr is present at the substrate corner 111A5, the protection tape 114A may cover the burr. The protection tape 114A may include an insulating polymer material such as PET (polyethylene terephthalate) or PPS (polyphenylene sulfide). These materials may maintain stable characteristics even at high temperatures and, since they are non-conductive, may provide a protective function without adversely affecting electrical characteristics of the battery. The protection tape may include or may be referred to as a buffer layer, an insulating tape, an insulating film, a reinforcing tape, or a reinforcing film.

Accordingly, when the protection tape 114A is attached to the substrate corner 111A5 of the first electrode plate 111A or to another vulnerable portion, folding or damage of that portion may be prevented. This may prevent an internal short circuit of the battery and contribute to improving overall safety. In addition, PET and PPS both have excellent heat resistance and are advantageous in maintaining stable performance over a long service life of a battery cell. Accordingly, they may contribute to improving durability and reliability of the battery.

The substrate 111A1 may include a first surface 111A7 facing the second active material layer 112A2 of the second electrode plate 112A located on the outer side of the substrate 111A1, and a second surface 111A8 opposite to the first surface 111A7 and facing the separator 113A located on the inner side of the substrate 111A1. In this configuration, the protection tape 114A may be attached to the first surface 111A7, such that the protection tape 114A faces the second active material layer 112A2 of the second electrode plate 112A. In other words, the inner side corresponds to a core region of the electrode assembly 110A, where at least three layers of separators 113A are present, while the outer side corresponds to a region in which the second electrode plate 112A is positioned with one layer of separator 113A interposed therebetween. Accordingly, when a substrate folding region 111A9 or a burr generated at the substrate corner 111A5 of the first substrate 111A1 is oriented toward the outer side, the folding region or burr may damage or penetrate the single separator layer 113A and may cause a short circuit with the second active material layer 112A2 of the second electrode plate 112A.

As described herein, by attaching the protection tape 114A to the first surface 111A7 of the first substrate 111A1, generation of the substrate folding region 111A9 of the first substrate 111A1 may be suppressed, thereby preventing damage to the separator 113A. However, in embodiments of the present disclosure, the protection tape 114A may also be attached to the second surface 111A8 of the first substrate 111A1, and such an arrangement is not excluded from aspects of the technology described herein. That is, in embodiments of the present disclosure, the protection tape 114A may cover both the first surface 111A7 and the second surface 111A8 of the first substrate 111A1.

Meanwhile, the outermost portion of the electrode assembly 110A may be finished with a finishing tape 116A, thereby preventing unwinding of the electrode assembly.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the herein formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x≤2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

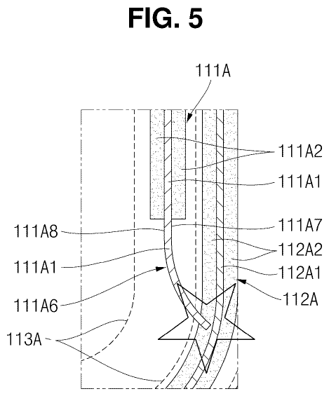

FIG. 5 illustrates damage to the separator 113A and a short-circuit phenomenon occurring in the electrode assembly 110A when the protection tape 114A is not provided. As shown in FIG. 5, when the protection tape 114A is not attached to the substrate corner 111A5 of the first substrate 111A1, a substrate folding region may occur. This folding region may damage the separator 113A or penetrate the separator 113A, thereby causing a short circuit with the second active material layer 112A2 of the second electrode plate 112A. Folding occurring at the substrate corner 111A5 of the first substrate 111A1 may affect the performance and safety of the battery. When the substrate is folded, the separator 113A may be physically damaged, which may lead to the occurrence of a short circuit. In particular, when the substrate folding region of the first electrode plate 111A corresponds to a bent region of the second electrode plate 112A, greater pressure may be applied to the folding region. As a result, damage to the separator 113A may occur more readily.

A short circuit between a substrate and an active material layer is known to be one of the most dangerous conditions in a secondary battery. When the substrate is folded and the separator is damaged in the electrode assembly, an unintended electrical connection may occur, thereby causing an internal short circuit. Such a condition may threaten the safety of the battery.

In embodiments of the present disclosure, the protection tape 114A covers the substrate corner 111A5 of the first substrate 111A1 to prevent folding of the substrate. This may prevent damage to the separator 113A and the occurrence of a short circuit, thereby improving the safety and reliability of the battery. Further, by applying the protection tape 114A according to embodiments of the present disclosure, damage to the separator 113A and short circuits caused by folding of the substrate may be prevented, thereby reducing potential risks that may arise therefrom. Accordingly, the stability of the battery may be significantly improved.

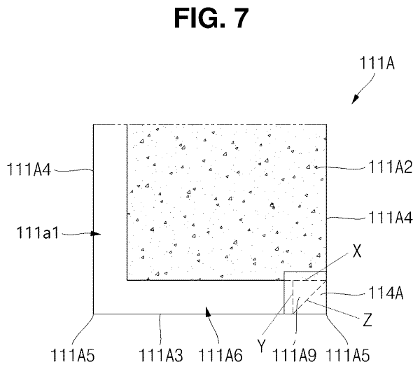

FIG. 6 illustrates a state in which the protection tape 114A is attached to an electrode plate according to embodiments of the present disclosure, and FIG. 7 is a plan view illustrating an electrode plate to which the protection tape 114A is attached according to embodiments of the present disclosure. As shown in FIGS. 6 and 7, a substrate folding region 111A9 (or a burr) that may be formed at the substrate corner 111A5 of the first substrate 111A1 is illustrated, and the protection tape 114A is attached to a region corresponding to the substrate folding region 111A9. Further, prior to attachment of the protection tape 114A, the substrate folding region 111A9 may or may not be formed during the manufacturing process.

As shown in FIGS. 6 and 7, the first substrate 111A1 may include a substrate horizontal edge 111A3 corresponding to the winding start end 111S of the first electrode plate 111A and extending parallel to a winding axis, a substrate vertical edge 111A4 perpendicular to the substrate horizontal edge 111A3, and a substrate corner 111A5 between the substrate horizontal edge 111A3 and the substrate vertical edge 111A4. As described herein, a region of the first substrate 111A1 exposed through the first active material layer 111A2 may be referred to as a uncoated substrate region 111A6. In addition, the first electrode plate 111A may include a substrate tab 111a1 on one side (for example, a left side) as described herein, and the substrate tab 111a1 may also be exposed without being coated with the first active material layer 111A2.

The protection tape 114A may be attached to the substrate corner 111A5. Accordingly, a portion of the substrate horizontal edge 111A3, excluding the substrate corner 111A5, may remain exposed from the protection tape 114A. In one or more embodiments, the protection tape 114A may cover only the substrate corner 111A5 without covering the entire region of the substrate horizontal edge 111A3. That is, the protection tape 114A may be attached only around the substrate corner 111A5, while the remaining portion of the substrate horizontal edge 111A3 may remain exposed. The protection tape 114A attached to the substrate corner 111A5 may prevent folding or damage of the substrate. Accordingly, safety and performance of the battery may be maintained.

The configuration in which the protection tape 114A covers only a portion of the substrate horizontal edge 111A3 may be cost-effective and may reduce unnecessary use of materials by providing protection only where needed. In addition, since a portion of the substrate horizontal edge 111A3 remains exposed, the structure may be configured so that the electrical characteristics of the battery are not adversely affected.

In embodiments of the present disclosure, the protection tape 114A is attached to the substrate corner 111A5 to prevent folding of the substrate, thereby improving safety and reliability. Further, the configuration in which the protection tape 114A covers only a portion of the substrate horizontal edge 111A3 provides an efficient and practical approach that enhances safety while satisfying functional requirements of the battery.

In one or more embodiments, the protection tape 114A may be attached on one side of the substrate corner 111A5 and may extend up to the first active material layer 111A2 that is parallel to the substrate horizontal edge 111A3. Accordingly, the protection tape 114A may cover a portion of the first active material layer 111A2. That is, the protection tape 114A may extend from the substrate corner 111A5 to the first active material layer 111A2, thereby providing additional protection to that region. Covering a portion of the first active material layer 111A2 with the protection tape 114A allows the corresponding region to be protected from folding or damage. In addition, the configuration in which the protection tape 114A covers only a portion of the first active material layer 111A2 provides localized protection where needed while avoiding adverse effects on overall battery performance.

In one or more embodiments, an area of the protection tape 114A may be set to approximately 100% to approximately 110% of an area of a maximum substrate folding region 111A9 that may occur at the substrate corner 111A5 of the first substrate 111A1. When the area of the protection tape 114A is smaller than approximately 100%, the substrate folding region 111A9 may not be sufficiently covered, which may allow folding of the substrate to occur. As a result, the risk of damage to the separator 113A or the occurrence of a short circuit may increase. When the area of the protection tape 114A is greater than approximately 110%, the protection tape 114A may excessively cover the first active material layer 111A2, which may adversely affect electrical characteristics or performance of the battery. Excessive coverage may reduce the efficiency of the battery.

By setting the area of the protection tape 114A within a range of approximately 100% to approximately 110% (which may include endpoints of the range, in some embodiments), the substrate folding region 111A9 may be sufficiently covered while excessive coverage may be prevented, thereby avoiding adverse effects on battery performance. Within this range, the protection tape 114A may efficiently and reliably protect the substrate while maintaining the performance of the battery.

The area of the protection tape 114A may be applied within a range of approximately 100% to approximately 110%, within which an optimal protection effect may be achieved. If the area is too small or too large, it may adversely affect the safety and performance of the battery. Accordingly, applying an appropriate area of the protection tape 114A is important.

In one or more embodiments, the protection tape 114A may cover a minimum square region including a diagonal length Z=√(X²+Y²) on the first substrate 111A1.

Here, X represents a maximum substrate folding horizontal distance formed along the substrate horizontal edge 111A3, Y represents a maximum substrate folding vertical distance formed along the substrate vertical edge 111A4, and Z represents a maximum substrate folding diagonal distance connecting one end of the maximum substrate folding horizontal distance and one end of the maximum substrate folding vertical distance in a diagonal direction.

In embodiments of the present disclosure, the protection tape 114A may be configured to cover a minimum square region corresponding to a diagonal length Z so as to sufficiently cover the substrate folding region 111A9. This region allows the portion where substrate folding is likely to occur to be protected.

In embodiments of the present disclosure, the protection tape 114A covers the minimum square region on the first substrate 111A1, thereby effectively preventing damage to the separator 113A and short circuits caused by substrate folding. In particular, by covering the region based on the diagonal length Z, sufficient protection may be provided in all directions in which folding may occur. Such a configuration effectively protects all regions in which substrate folding may occur while reducing the risk of degrading battery performance.

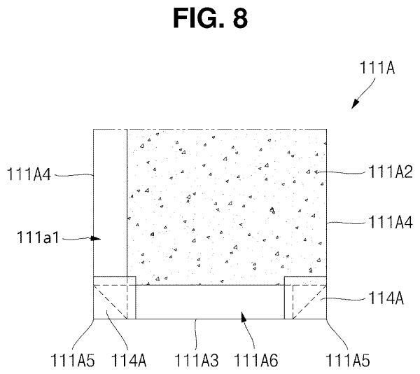

FIG. 8 is a plan view illustrating an electrode plate to which protection tapes 114A are attached according to another embodiment of the present disclosure. As shown in FIG. 8, the substrate corners 111A5 may be provided at both sides of the substrate horizontal edge 111A3. Accordingly, the protection tapes 114A may also be attached at both sides, respectively. This configuration provides protection at both sides of the electrode plate in order to improve the safety of the battery.

In one or more embodiments, a left-side region of the first electrode plate 111A may be defined as a substrate tab 111a1, and the protection tape 114A may be attached to a portion of the substrate tab 111a1. The substrate tab 111a1 functions to be electrically connected to a terminal in the electrode assembly 110A of the battery. By attaching the protection tape 114A to a portion of the substrate tab 111a1, mechanical stability and electrical protection of that portion may be enhanced. Attaching the protection tape 114A to a portion of the substrate tab 111a1 contributes to ensuring electrical characteristics and mechanical stability of the electrode plate. This may improve safety and service life of the battery cell.

Meanwhile, in embodiments of the present disclosure, the protection tape has been described as being applied to the first substrate corner at the winding start end. However, the protection tape may also be applied to a second substrate corner at the winding start end. When the protection tape is applied to the second substrate corner at the winding start end, a substrate folding region that may occur at the second substrate corner may be prevented from causing a short circuit with the first active material layer of the first electrode plate. The configuration or shape of the protection tape applied to the second substrate corner may be similar or identical to that described herein.

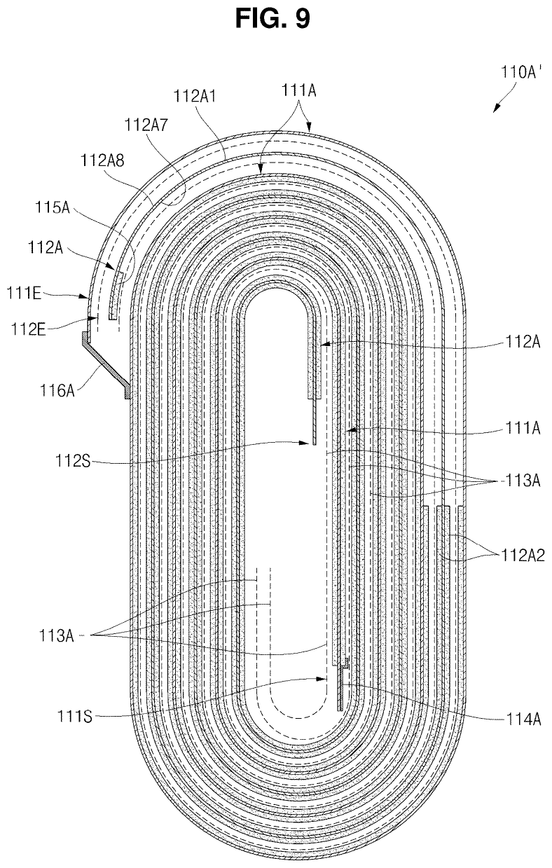

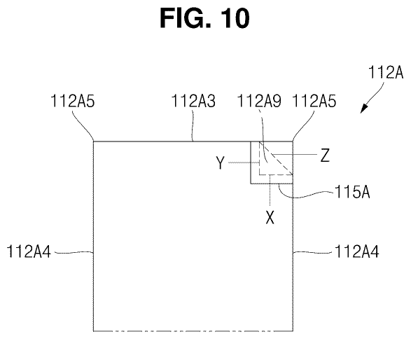

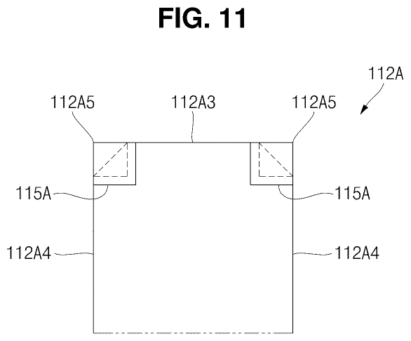

FIG. 9 is a cross-sectional view illustrating an electrode assembly 110A′ according to another embodiment of the present disclosure. FIG. 10 is a plan view illustrating an electrode plate to which a protection tape 115A is attached according to another embodiment of the present disclosure. FIG. 11 is a plan view illustrating an electrode plate to which a protection tape 115A is attached according to another embodiment of the present disclosure.

In the examples illustrated in FIGS. 9 to 11, the protection tape 115A (i.e., a terminal protection tape) may be attached not only to the first electrode plate 111A but also to the second electrode plate 112A. In one or more embodiments, the second substrate 112A1 of the second electrode plate 112A may include a first surface 112A7 facing the first electrode plate 111A positioned inwardly, and a second surface 112A8 opposite the first surface 112A7, the second surface facing the first electrode plate 111A positioned outwardly. The terminal protection tape 115A may be attached to the first surface 112A7 and/or the second surface 112A8. Here, the terminal protection tape 115A may include an insulating tape that is the same as or similar to the protection tape 114A described herein.

As described herein, the second electrode plate 112A may include a second substrate 112A1. The second substrate 112A1 may correspond to a winding terminal end 112E of the second electrode plate 112A, and may include a terminal substrate horizontal edge 112A3 parallel to a winding axis, a terminal substrate vertical edge 112A4 perpendicular to the terminal substrate horizontal edge 112A3, and a terminal substrate corner 112A5 located between the terminal substrate horizontal edge 112A3 and the terminal substrate vertical edge 112A4.

In one or more embodiments, the terminal protection tape 115A may be attached to the terminal substrate corner 112A5. In one or more embodiments, at least a portion of the terminal substrate horizontal edge 112A3, excluding the terminal substrate corner 112A5, may remain exposed from the terminal protection tape 115A.

In one or more embodiments, an area of the terminal protection tape 115A may be approximately 100% to approximately 110% of an area of a maximum substrate folding region 112A9 that may occur at the terminal substrate corner 112A5 of the second substrate 112A1.

In one or more embodiments, the terminal protection tape 115A may cover a minimum square region having a diagonal length Z=√(X²+Y²).

Here, X represents a maximum substrate folding horizontal distance formed along the terminal substrate horizontal edge 112A3, Y represents a maximum substrate folding vertical distance formed along the terminal substrate vertical edge 112A4, and Z represents a maximum substrate folding diagonal distance connecting one end of the maximum substrate folding horizontal distance and one end of the maximum substrate folding vertical distance in a diagonal direction.

In one or more embodiments, the terminal substrate corners 112A5 may be provided on both sides of the terminal substrate horizontal edge 112A3, and respective terminal protection tapes 115A may be attached to the terminal substrate corners 112A5 provided on the two sides. Here, the two terminal protection tapes 115A may be spaced apart from each other, and at least a portion of the terminal substrate horizontal edge 112A3 between the two terminal protection tapes 115A may remain exposed.

Accordingly, in embodiments of the present disclosure, the protection tape may cover a substrate folding region of the electrode plate, thereby preventing an internal short circuit and improving the safety of the battery. In addition, by preventing folding or damage of the substrate, the protection tape may extend the service life of the battery and maintain stable performance. Further, the protection tape may be formed of commercially available materials (e.g., PET, PPS, etc.), thereby improving performance without incurring significant additional cost. The embodiments of the present disclosure may be readily applied to existing manufacturing processes and may be applied to various types of battery cells.

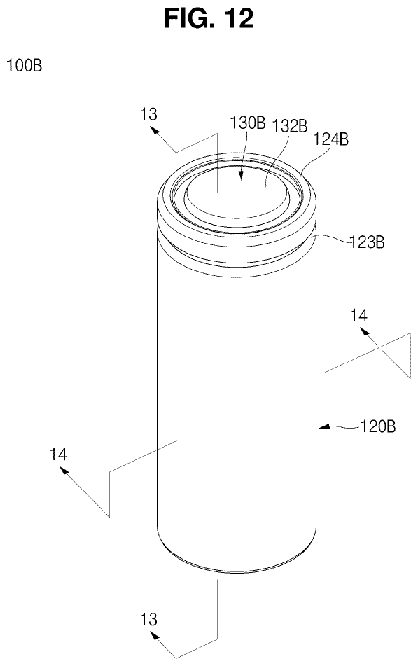

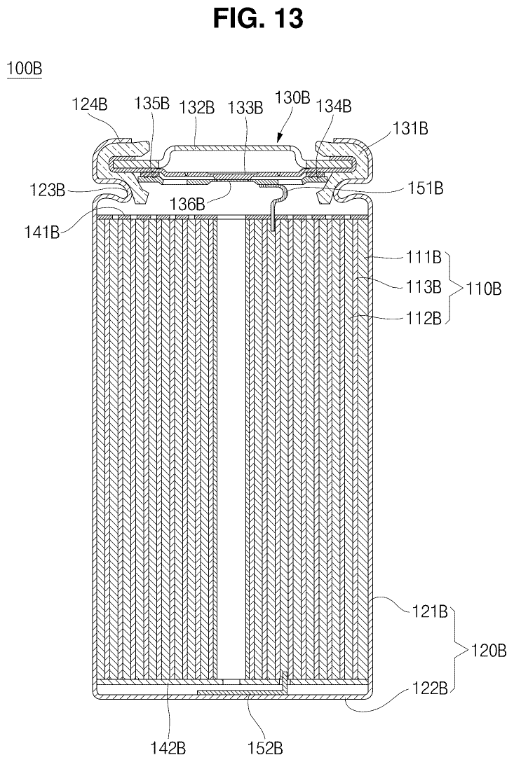

FIG. 12 is a perspective view illustrating a secondary battery 100B according to another embodiment of the present disclosure, and FIG. 13 is a cross-sectional view taken along line 13-13 of FIG. 12. In the example illustrated in FIGS. 12 and 13, the secondary battery 100B may include an electrode assembly 110B, a case 120B configured to accommodate the electrode assembly 110B and an electrolyte therein, and a cap assembly 130B coupled to an opening of the case 120B to seal the case 120B.

The electrode assembly 110B may include a first electrode plate 111B, a second electrode plate 112B, and a separator 113B disposed between the first and second electrode plates. The electrode assembly 110B may be provided in a cylindrical form in which the first electrode plate 111B, the second electrode plate 112B, and the separator 113B disposed therebetween are stacked and wound together. The first electrode plate 111B may include a first substrate and a first active material layer disposed on the first substrate. A first lead tab 151B may extend outward from a first uncoated region of the first substrate where the first active material layer is not formed, and the first lead tab 151B may be electrically connected to the cap assembly 130B. The second electrode plate 112B may include a second substrate and a second active material layer disposed on the second substrate. A second lead tab 152B may extend outward from a second uncoated region of the second substrate where the second active material layer is not formed, and the second lead tab 152B may be electrically connected to the case 120B. The first lead tab 151B and the second lead tab 152B may extend in opposite directions from each other.

The case 120B may accommodate the electrode assembly 110B and an electrolyte, and may form an exterior of the secondary battery 100B together with the cap assembly 130B. The case 120B may include a cylindrical body portion 121B and a bottom portion 122B connected to one side of the body portion 121B. A beading portion 123B, which is deformed inward, may be disposed at approximately an upper portion of the body portion 121B, and a crimping portion 124B, which is bent inward, may be disposed at an opening-side end of the body portion 121B.

The beading portion 123B may suppress movement of the electrode assembly 110B within the case 120B, and may facilitate seating of the gasket 131B and the cap assembly 130B. The crimping portion 124B may press an edge of the cap assembly 130B via the gasket 131B to thereby firmly secure the cap assembly 130B. The case 120B may be formed of stainless steel (SUS), nickel-plated steel, or aluminum.

The cap assembly 130B may be fixed to an inner side of the crimping portion 124B via the gasket 131B, thereby sealing the case 120B. The cap assembly 130B may include a cap-up 132B, a safety vent 133B, a cap-down 134B, an insulating member 135B, and a sub-plate 136B, although the cap assembly 130B is not limited to these examples and may be variously modified.

The cap-up 132B may be disposed at an uppermost portion of the cap assembly 130B. The cap-up 132B may include a terminal portion that protrudes upward in a convex shape for connection to an external circuit, and one or more vent holes for discharging gas may be disposed around the terminal portion. The safety vent 133B may be disposed below the cap-up 132B. The safety vent 133B may protrude downward in a convex shape and may be connected to the sub-plate 136B.

When gas is generated due to overcharging or abnormal operation of the secondary battery 100B, the safety vent 133B may be deformed upward by internal pressure and separated from the sub-plate 136B, while the safety vent 133B may be ruptured. The ruptured safety vent 133B may discharge gas to the outside, thereby preventing explosion of the secondary battery 100B.

The cap-down 134B may be disposed below the safety vent 133B. The cap-down 134B may include a first opening for exposing a protrusion of the safety vent 133B, and a second opening for discharging gas. The insulating member 135B may be disposed between the safety vent 133B and the cap-down 134B to electrically insulate the safety vent 133B from the cap-down 134B. The sub-plate 136B may be disposed below the cap-down 134B. The sub-plate 136B may be fixed to a lower surface of the cap-down 134B so as to cover the first opening of the cap-down 134B, and the protrusion of the safety vent 133B may be fixed to the sub-plate 136B. The first lead tab 151B drawn from the electrode assembly 110B may be fixed to the sub-plate 136B or the cap-down 134B. Accordingly, the cap-up 132B, the safety vent 133B, the cap-down 134B, and the sub-plate 136B may be electrically connected to the first electrode plate 111B of the electrode assembly 110B.

A first insulating plate 141B may be interposed between the electrode assembly 110B and the cap assembly 130B, and a second insulating plate 142B may be interposed between the electrode assembly 110B and the bottom portion 122B of the case 120B.

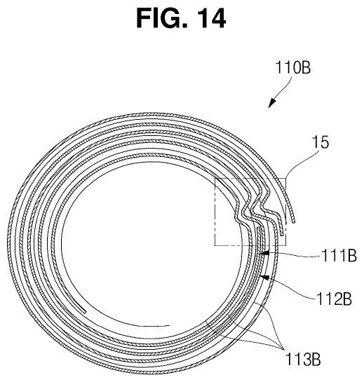

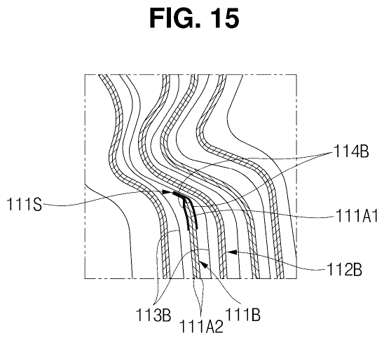

FIG. 14 is a cross-sectional view taken along line 14-14 of FIG. 12, and FIG. 15 is an enlarged view of region 15 of FIG. 14. For ease of understanding of the present disclosure, the case is not illustrated. As shown in FIGS. 14 and 15, when core deformation occurs near a winding start end 111S of the first electrode plate 111B, local stress may be concentrated at that portion, and the separator 113B may be torn, which may cause an internal short circuit. In particular, when core deformation occurs near the winding start end 111S of the first substrate 111A1 of the first electrode plate 111B, the risk of formation of an internal short-circuit path may increase. Accordingly, in order to avoid such a risk, according to embodiments of the present disclosure, a protection tape 114B may be provided at an winding start end of the first electrode plate 111B in the manner described herein.

In one or more embodiments, the protection tape 114B may cover a sharp end portion of the first electrode plate 111B or the first substrate 111A1, thereby making it more difficult for the separator 113B disposed nearby to be torn. In one or more embodiments, the protection tape 114B may cover both a first surface of the first substrate 111A1 and a second surface opposite to the first surface, and may further extend to cover a portion of the first active material layer 111A2 disposed on the first surface and the second surface.

Here, as described herein, the protection tape 114 may be attached only to a substrate corner on one side or substrate corners on both sides of the first electrode plate 111B, and does not cover the entire substrate horizontal edge. That is, at least a portion of the substrate horizontal edge may remain exposed outwardly without being covered by the protection tape 114.

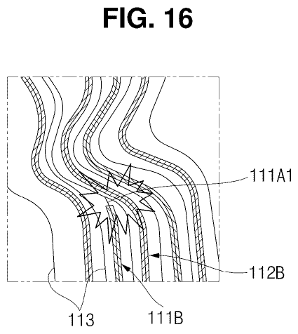

FIG. 16 is a view illustrating separator damage and a short-circuit phenomenon in the electrode assembly 110B when the protection tape 114 is not provided. As shown in FIG. 16, when a substrate folding region (i.e., a burr) is formed on the first substrate 111A1 of the first electrode plate 111B in the absence of the protection tape 114, the substrate folding region may damage the separator 113B. Further, the substrate folding region of the first substrate 111A1 may penetrate the separator 113B and come into electrical contact with the second active material layer 112A2 of the second electrode plate 112B, thereby causing a short circuit.

As described herein, in embodiments of the present disclosure, the protection tape 114 is attached in advance to a region where substrate folding is expected to occur, thereby preventing formation of a substrate folding region, and consequently preventing damage to the separator 113B or occurrence of an internal short circuit.

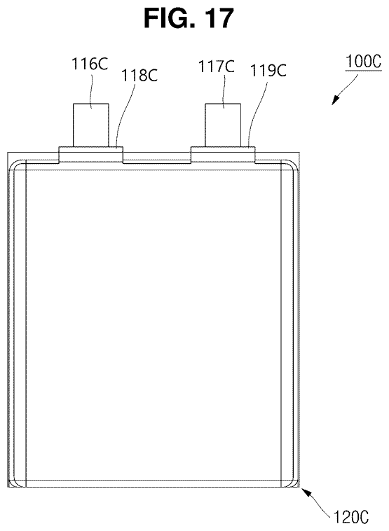

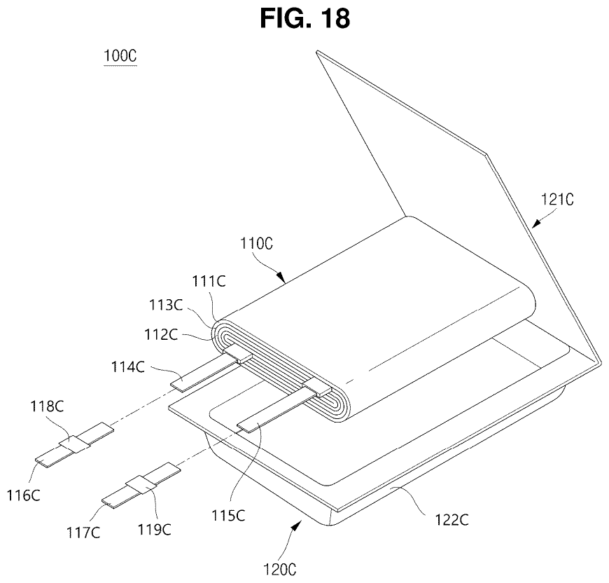

FIG. 17 is a plan view illustrating a secondary battery 100C according to another embodiment of the present disclosure, and FIG. 18 is an exploded perspective view illustrating the secondary battery 100C according to another embodiment of the present disclosure. As shown in FIGS. 17 and 18, the secondary battery 100C according to embodiments of the present disclosure may include an electrode assembly 110C and a case 120C. The secondary battery 100C may further include a first electrode tab 116C and a second electrode tab 117C for electrical connection.

The electrode assembly 110C may include a first electrode plate 111C, a second electrode plate 112C, and a separator 113C interposed between the first and second electrode plates, and these components may be stacked and wound into a substantially jelly-roll shape.

The case 120C may accommodate the electrode assembly 110C and may be provided by sealing an outer periphery of the electrode assembly 110C. The case 120C may include, or may be referred to as, an exterior material, a pouch, a can, or a housing. In one or more embodiments, the case 120C may be provided in a laminate structure including, for example, a first insulating layer, a metal layer, and a second insulating layer.

In one or more embodiments, the case 120C may include a first case 121C and a second case 122C, one end of which is connected to the first case 121C, and which includes a recess having a predetermined depth configured to accommodate the electrode assembly 110C. In one or more embodiments, peripheral portions of the first and second cases 121C and 122C corresponding to an outer periphery of the electrode assembly 110C may be thermally fused to each other, such that the electrode assembly 110C may be accommodated within an interior of a pouch-type or pocket-type case.

In one or more embodiments, the case 120C may be provided by bending a rectangular plate-shaped case integrally formed along a longitudinal direction of one side of the rectangular plate, such that a first case 121C and a second case 122C are formed. The second case 122C may include a recess having a predetermined depth configured to accommodate the electrode assembly 110C, the recess being formed through press processing or drawing processing. A sealing region for sealing with the first case 121C may be provided along an outer periphery of the recess. The sealing region may be provided along one side where the first case 121C and the second case 122C are integrally connected and along the remaining three sides.

In one or more embodiments, the case 120C may be provided of stainless steel. In this case, sealing of the stainless steel case may be performed by laser welding.

A first tab 114C of the electrode assembly 110C may be welded to a first electrode tab 116C, and a second tab 115C may be welded to a second electrode tab 117C. In one or more embodiments, the first electrode tab 116C and the second electrode tab 117C may extend outward by a predetermined length through the case 120C, with a first sealing tape 118C and a second sealing tape 119C interposed therebetween, respectively. In one or more embodiments, a region of the case 120C from which the first electrode tab 116C and the second electrode tab 117C extend outward may be referred to as a terrace.

According to embodiments of the present disclosure, the protection tape covers a substrate folding region of the electrode plate, thereby preventing an internal short circuit that may occur at the corresponding portion and improving safety of the battery.

In addition, according to embodiments of the present disclosure, the protection tape is configured to prevent folding or damage of the substrate in the battery cell, thereby extending a service life of the battery and maintaining stable performance of the battery.

In addition, according to embodiments of the present disclosure, the protection tape may include commercially available materials (e.g., PET, PPS, etc.), and may be easily applied to existing manufacturing processes, thereby enabling provision of a secondary battery having improved performance without incurring additional cost.

In addition, according to embodiments of the present disclosure, the protection tape may be applicable to prismatic-type, cylindrical-type, or pouch-type battery cells, thereby improving performance of various types of lithium-ion battery cells.

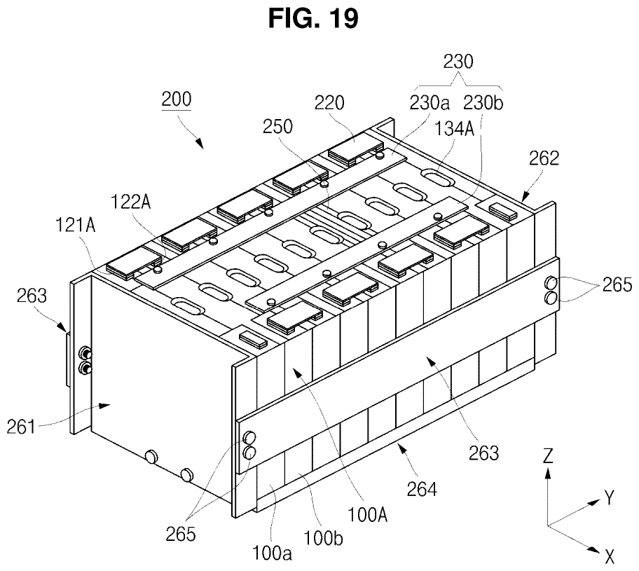

FIG. 19 is a perspective view illustrating a battery module 200 according to one or more embodiments of the present disclosure. Referring to FIG. 19, the battery module 200 according to one or more embodiments of the present disclosure includes electrode units 121 and 122, a plurality of battery cells 100 arranged in one direction (e.g., the Y-axis direction), a connection tab 220 connecting a battery cell 100a to an adjacent battery cell 100b, and a protection circuit module 230 having one end connected to the connection tab 220. The protection circuit module 230 may include a battery management system (BMS). Further, the connection tab 220 may include a body portion in contact with the electrode units 121 and 122 between the adjacent battery cells 100a and 100b and an extension portion extending from the body portion and connected to the protection circuit module 230. The connection tab 220 may be, for example, a bus bar.

Each battery cell 100 may include a battery case, an electrode assembly received (or accommodated) in the battery case, and an electrolyte. The electrode assembly and the electrolyte react electrochemically to store and release (e.g., generate) energy. Terminal parts 121 and 122 electrically connected to the connection tab 220 and a vent 134 as a discharge passage for gas generated inside the battery case may be provided on one side of (e.g., an upper side of) the battery cell 100. The terminal parts 121 and 122 of the battery cell 100 may be a positive electrode terminal 121 and a negative electrode terminal 122 having different polarities from each other, and the terminal parts 121 and 122 of the adjacent battery cells 100a and 100b may be electrically connected to each other in series or parallel by the connection tab 220, to be described in more detail below. Although a serial connection has been described as an example, various connection structures may be employed as desired or necessary. In addition, the number and arrangement of battery cells is not limited to the structure shown in FIG. 19 and may be changed as desired or necessary.

The plurality of battery cells 100 may be arranged in (e.g., may be stacked in) one direction so that the wide surfaces of the battery cells 100 face each other, and the plurality of battery cells 100 may be fixed by the housings 261, 262, 263, and 264. The housings 261, 262, 263, and 264 may include a pair of end plates 261 and 262 facing the wide surfaces of the battery cell 100 and a side plate 263 and a bottom plate 264 connecting the pair of end plates 261 and 262 to each other. The side plate 263 may support side surfaces of the battery cells 100, and the bottom plate 264 may support bottom surfaces of the battery cells 100. In addition, the pair of end plates 261 and 262, the side plate 263 and the bottom plate 264 may be connected by bolts 265 and/or any other suitable fastening members and methods known to those of ordinary skill in the art. In some examples, the bottom plate 264 may include or be referred to as a cooling plate.

The protection circuit module 230 may have electronic components and protection circuits mounted thereon and may be electrically connected to connection tabs 220, to be described in more detail later. The protection circuit module 230 includes a first protection circuit module 230a and a second protection circuit module 230b extending along the direction in which the plurality of battery cells 100 are arranged in different locations. The first protection circuit module 230a and the second protection circuit module 230b may be spaced from each other at a suitable interval (e.g., a predetermined interval) and arranged parallel to each other to be electrically connected to adjacent connection tabs 220, respectively. For example, the first protection circuit module 230a extends on one side of the upper portion of the plurality of battery cells 100 along the direction in which the plurality of battery cells 100 are arranged, and the second protection circuit module 230b extends to the other upper side of the plurality of battery cells 100 along the direction in which the plurality of battery cells 100 are arranged. The second protection circuit module 230b may be spaced from the first protection circuit module 230a at a suitable interval (e.g., a predetermined interval) with the vents 134 interposed therebetween but may be disposed parallel to the first protection circuit module 230a. As such, the two protection circuit modules are spaced from each other side-by-side along the direction in which the plurality of battery cells 100 are arranged, thereby reducing or reducing the area of the printed circuit board (PCB) constituting the protection circuit module. By separately configuring the protection circuit module into two protection circuit modules, unnecessary protection circuit module area can be reduced or minimized. In addition, the first protection circuit module 230a and the second protection circuit module 230b may be connected to each other by a conductive connection member 250. One side of the conductive connection member 250 is connected to the first protection circuit module 230a, and the other side thereof is connected to the second protection circuit module 230b so that the two protection circuit modules 230a and 230b can be electrically connected with each other.

The connection may be performed by any one of soldering, resistance welding, laser welding, projection welding and/or any other suitable connection methods known to those of ordinary skill in the art.

In addition, the connection member 250 may be, for example, an electric wire. In addition, the connection member 250 may be made of a material having elasticity or flexibility. By the connection member 250, it may be possible to check and manage whether the voltage, temperature, and/or current of the plurality of battery cells 100 are normal. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 250.

In addition, when a battery cell 100 swells, shocks may be absorbed by the elasticity or flexibility of the connection member 250, thereby preventing the first and second protection circuit modules 230a and 230b from being damaged.

In addition, the shape and structure of the connection member 250 may vary from the shape and structure shown in FIG. 19.

As described above, because the protection circuit module 230 is provided as the first and second protection circuit modules 230a and 230b, the area of the PCB constituting the protection circuit module can be reduced or minimized, and the space inside the battery module can be secured, which improves work efficiency by facilitating a fastening work for connecting the connection tab 220 and the protection circuit module 230 and repair work if (or when) an abnormality is detected in the battery module.

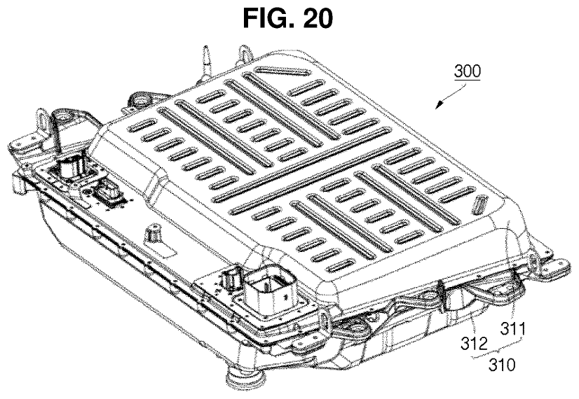

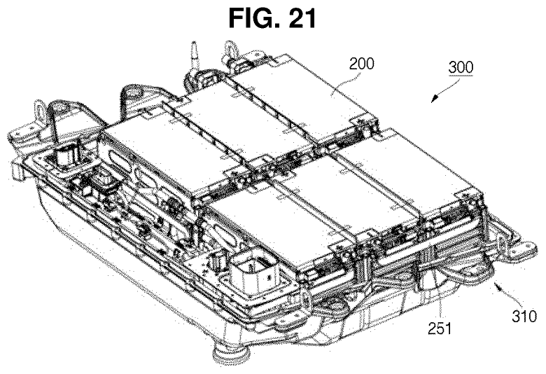

FIGS. 20 and 21 are perspective views showing a battery pack 300 including an exemplary cylindrical secondary battery according to the present disclosure. Referring to FIGS. 20 and 21, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the FIGS. 20 and 21, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

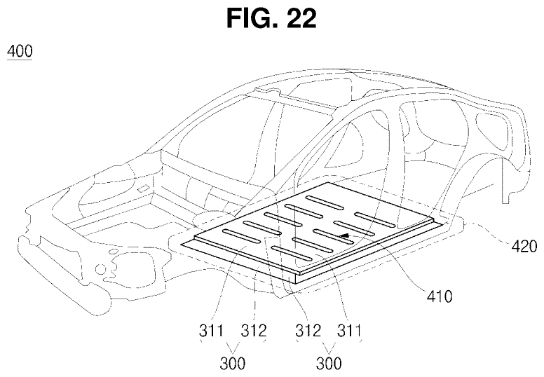

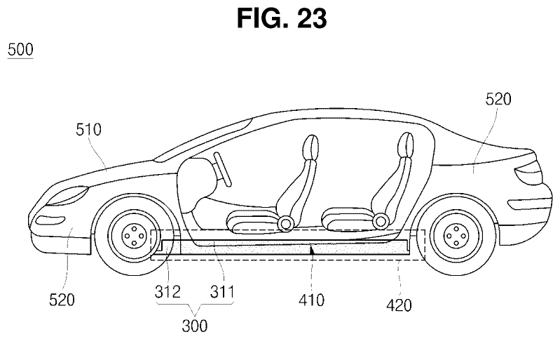

FIGS. 22 and 23 are a perspective view and a side view showing vehicles 400 and 500 including the exemplary battery pack 300 according to the present disclosure. In FIG. 22, a battery pack 300 may include a battery pack cover 311 (may correspond to the first housing above), which is a part of a vehicle underbody 410, and a pack frame 312 (may correspond to the second housing above) disposed under the vehicle underbody 410. The pack frame 312 and the battery pack cover 311 may be integrally formed with a vehicle floor 420. The vehicle underbody 410 separates the inside and outside of a vehicle, and the pack frame 312 may be disposed outside the vehicle.

In FIG. 23, a vehicle 500 may be formed by combining additional parts, such as a hood 510 in front of the vehicle and fenders 520 respectively located in the front and rear of the vehicle to a vehicle body parts 400. The vehicle 500 may further include a vehicle floor 420, which is one of the vehicle body parts 400 including the battery pack 300 including the pack frame 312 and the battery pack cover 311.

However, aspects and features of the present disclosure are not limited to those described herein, and other aspects and features not mentioned will be clearly understood by a person skilled in the art from the detailed description, described herein.

Although the present disclosure has been described herein with limited examples and drawings, the present disclosure is not limited thereto, and it is obvious that various modifications and variations may be made by those skilled in the art in the technical field to which the present disclosure belongs within the technical idea of the present disclosure.

What is claimed is:

1. An electrode assembly, comprising:
a first electrode plate comprising a first substrate and a first active material layer disposed on the first substrate, the first substrate comprising:
a substrate horizontal edge corresponding to a winding start end of the first electrode plate and extending parallel to a winding axis;
a substrate vertical edge perpendicular to the substrate horizontal edge; and
a substrate corner between the substrate horizontal edge and the substrate vertical edge;
a second electrode plate comprising a second substrate and a second active material layer disposed on the second substrate;
a separator between the first electrode plate and the second electrode plate; and
a protection tape attached to the substrate corner, wherein at least a portion of the substrate horizontal edge, excluding the substrate corner, is exposed from the protection tape.

2. The electrode assembly of claim 1,
wherein an area of the protection tape is 100% to 110% of an area of a maximum substrate folding region generated at the substrate corner of the first substrate.

3. The electrode assembly of claim 1,
wherein the protection tape covers, on the first substrate, a minimum square region comprising a diagonal length Z=√(X²+Y²),
wherein X is a maximum horizontal substrate folding distance formed on the substrate horizontal edge, Y is a maximum vertical substrate folding distance formed on the substrate vertical edge, and Z is a maximum diagonal substrate folding distance connecting one end of the maximum horizontal substrate folding distance and one end of the maximum vertical substrate folding distance in a diagonal direction.

4. The electrode assembly of claim 1,
wherein the protection tape is attached from one side of the substrate corner to the first active material layer that extends parallel to the substrate horizontal edge.

5. The electrode assembly of claim 1,
wherein the substrate corner is provided at both sides of the substrate horizontal edge, and the protection tape is attached to each of the substrate corners provided at the both sides of the substrate horizontal edge.

6. The electrode assembly of claim 1,
wherein the first substrate comprises a first surface facing the second active material layer of the second electrode plate on an outer side of the first substrate, and a second surface opposite to the first surface and facing the separator on an inner side of the first substrate, and wherein the protection tape is attached to the first surface.

7. The electrode assembly of claim 1,
wherein the protection tape comprises PET (polyethylene terephthalate) or PPS (polyphenylene sulfide).

8. The electrode assembly of claim 1,
wherein the first electrode plate, the second electrode plate, and the separator between the first electrode plate and the second electrode plate are stacked together and wound in a jelly-roll form.

9. The electrode assembly of claim 1,
wherein the first electrode plate, the second electrode plate, and the separator between the first electrode plate and the second electrode plate are stacked together and wound in a cylindrical form.

10. The electrode assembly of claim 1,
wherein the first electrode plate is a positive electrode plate, and the second electrode plate is a negative electrode plate.

11. The electrode assembly of claim 1,
wherein the second substrate comprises a terminal substrate horizontal edge corresponding to a winding terminal end of the second electrode plate and extending parallel to the winding axis, a terminal substrate vertical edge perpendicular to the terminal substrate horizontal edge, and a terminal substrate corner between the terminal substrate horizontal edge and the terminal substrate vertical edge, wherein the electrode assembly further comprises a terminal protection tape attached to the terminal substrate corner, and wherein at least a portion of the terminal substrate horizontal edge, excluding the terminal substrate corner, is exposed from the terminal protection tape.

12. The electrode assembly of claim 11,
wherein an area of the terminal protection tape is 100% to 110% of an area of a maximum substrate folding region generated at the terminal substrate corner of the second substrate.

13. The electrode assembly of claim 11,
wherein the terminal protection tape covers, on the second substrate, a minimum square region comprising a diagonal length Z=√(X²+Y²),
wherein X is a maximum horizontal substrate folding distance formed on the terminal substrate horizontal edge, Y is a maximum vertical substrate folding distance formed on the terminal substrate vertical edge, and Z is a maximum diagonal substrate folding distance connecting one end of the maximum horizontal substrate folding distance and one end of the maximum vertical substrate folding distance in a diagonal direction.

14. The electrode assembly of claim 11,
wherein the terminal substrate corner is provided at both sides of the terminal substrate horizontal edge, and the terminal protection tape is attached to each of the terminal substrate corners provided at the both sides.

15. The electrode assembly of claim 11,
wherein the second substrate comprises a first surface facing the first electrode plate on an inner side of the second substrate and a second surface opposite to the first surface and facing the first electrode plate on an outer side of the second substrate, and wherein the terminal protection tape is attached to the first surface or the second surface.

16. The electrode assembly of claim 11,
wherein the terminal protection tape comprises an insulating tape.

17. A secondary battery comprising the electrode assembly of claim 1.

18. The secondary battery of claim 17,
wherein the electrode assembly is accommodated in a prismatic metal case.

19. The secondary battery of claim 17,
wherein the electrode assembly is accommodated in a cylindrical metal case.

20. The secondary battery of claim 17,
wherein the electrode assembly is accommodated in a pouch-type exterior material.
